(19) United States
(12) Patent Application Publication
(10) Pub. No.: US 2026/0037837 A1
(43) Pub. Date: Feb. 5, 2026

(54) RETRIEVAL-AUGMENTED GENERATION METHOD, SYSTEM, DEVICE, AND MEDIUM AND QUESTION-ANSWERING METHOD

(71) Applicant: SHENZHEN INSTITUTES OF ADVANCEDTECHNOLOGY CHINESE ACADEMY OF SCIENCES, Shenzhen (CN)

(72) Inventor: Chengke WU, Shenzhen (CN)

(73) Assignee: SHENZHEN INSTITUTES OF ADVANCEDTECHNOLOGY CHINESE ACADEMY OF SCIENCES, Shenzhen (CN)

(21) Appl. No.: 19/291,030

(22) Filed: Aug. 5, 2025

(30) Foreign Application Priority Data
Aug. 5, 2024 (CN) 2024110637912

(51) Int. Cl. G06N 5/022; G06F 16/2455

(52) U.S. Cl. CPC G06N 5/022; G06F 16/2455

(57) ABSTRACT

A retrieval-augmented generation method, system, device, and medium and a question-answering method are provided, belonging to the field of data processing technology. The retrieval-augmented generation method includes: acquiring a query statement to be retrieved; converting the query statement to be retrieved into K knowledge fragments to be augmented based on a trained embedding model; and inputting the K knowledge fragments to be augmented into the trained recommendation model to obtain several augmented knowledge fragments and their sequencing. The method, system, device, and medium can perform data interaction based on user preferences and usage habits.

### CROSS-REFERENCE TO RELATED APPLICATIONS

The application claims priority to Chinese patent application No. 2024110637912, filed on Aug. 5, 2024, the entire contents of which are incorporated herein by reference.

### TECHNICAL FIELD

The present disclosure belongs to the field of data processing technology, and relates to a retrieval-augmented generation method, system, device, and medium and a question-answering method.

### BACKGROUND

In the current mainstream retrieval-augmented generation (RAG) method, any document undergoes direct, often called “brute-force,” fragmentation. This involves either splitting the text into fixed-length chunks or first segmenting it into sentences using punctuation marks and then combining these sentences into fragments until the maximum allowed size is reached. Then, the fragments are vectorized, and their similarity to the vectorized user query is computed. After identifying the knowledge fragment(s) most similar to the query statement, they are incorporated into the prompt. This augmented prompt is then input to the large language model (LLM) to generate an answer to the user's question.

The problem with this method is that the vectorization of knowledge fragments is based on the same embedding model (such as BAAI-M3, BERT-base-uncased, etc.). These models are pre-trained based on massive public corpus data. Their input is the text in the knowledge fragment and their output is a fixed-dimensional semantic vector, such as 1024 dimensions. This process is called embedding. The parameters of the pre-trained model that the embedding process relies on are unchanged, so for each query, when the input query statement remains unchanged, the closest knowledge fragment obtained is always consistent. However, users may have their own preferences for a query question. For example, for the question “Information on key management personnel of xx unit”, RAG gives similar knowledge fragments, such as Fragment 6. User A may prefer to use Fragments 1, 2, and 3, while User B may tend to use Fragments 2, 3, and 4. Even due to the limitations of the model itself, there may not be a fragment that meets the user's query requirements among the first 6 fragments, so the user needs to manually enter the correct fragment path. The current RAG cannot capture this type of interactive data that is closely related to user preferences and usage habits, making it difficult to optimize its accuracy based on the usage process and unable to achieve large-scale customized deployment.

### SUMMARY

The objective of the present disclosure is to overcome the shortcomings of the above-mentioned prior art and provide a retrieval-augmented generation method, system, device, and medium and a question-answering method, which can perform data interaction based on user preferences and usage habits.

To achieve the above objective, the present disclosure provides the following technical solutions:

In a first aspect of the present disclosure, the retrieval-augmented generation method of the present disclosure includes:
acquiring a query statement to be retrieved;
converting the query statement to be retrieved into K knowledge fragments to be augmented based on a trained embedding model; and
inputting the K knowledge fragments to be augmented into the trained recommendation model to obtain several augmented knowledge fragments and their sequencing.

The retrieval-augmented generation method of the present disclosure is further improved in that:
further, the process of converting the query statement to be retrieved into K knowledge fragments to be augmented based on a trained embedding model is as follows:
converting the query statement to be retrieved into a dense semantic vector by means of an embedding model; and
querying K knowledge fragments that have the smallest semantic vector cosine distance from the dense semantic vector in the RAG knowledge base, and using the queried K knowledge fragments as the K knowledge fragments to be augmented.

Further, before inputting the K knowledge fragments to be augmented into the trained recommendation model, the method further includes:
building a training set and a test set;
building a recommendation model; and
training and testing the recommendation model using the training set and the test set to obtain a trained recommendation model.

Further, the process of building a training set and a test set is as follows:
acquiring several query statement samples;
converting the query statement sample into a dense semantic vector sample by means of the embedding model;
querying K knowledge fragment samples that have the smallest semantic vector cosine distance from the dense semantic vector samples in the RAG knowledge base, where a user selects K′ knowledge fragment samples from the K knowledge fragment samples; and
building a training set and a test set, with the K knowledge fragment samples and their sequencing as input, and the K′ knowledge fragment samples selected by the user and the sequence selected by the user as output.

Further, the process of building a recommendation model is as follows:
building a recommendation model based on the Bi-LSTM network.
In a second aspect of the present disclosure, the retrieval-augmented generation system of the present disclosure includes:
a first acquisition module, configured to obtain the query statement to be retrieved;
a first conversion module, configured to convert the query statement to be retrieved into K knowledge fragments to be augmented based on a trained embedding model; and
a first augmentation module, configured to input the K knowledge fragments to be augmented into the trained recommendation model to obtain several augmented knowledge fragments and their sequencing.

In a third aspect of the present disclosure, a computer device of the present disclosure includes a storage, a processor, and a computer program stored in the storage and executable on the processor. When the processor performs the computer program, the steps of the retrieval-augmented generation method are implemented.

In a fourth aspect of the present disclosure, a computer-readable storage medium is provided. The computer-readable storage medium stores a computer program, and when the computer program is performed by a processor, the steps of the retrieval-augmented generation method are implemented.

In a fifth aspect of the present disclosure, a question-answering method of the present disclosure includes:
acquiring a query question;
converting the query question into K knowledge fragments to be augmented based on a trained embedding model;
inputting the K knowledge fragments to be augmented into the trained recommendation model to obtain several augmented knowledge fragments and their sequencing; and
splicing the augmented knowledge fragments according to their sequencing, embedding them in the prompt template, and then inputting it into a large language model to obtain a user's preferred answer to the question.

In a sixth aspect of the present disclosure, the question-answering system of the present disclosure includes:
a second acquisition module, configured to acquire a query question;
a second conversion module, configured to convert the query question into K knowledge fragments to be augmented based on a trained embedding model;
a second augmentation module, configured to input the K knowledge fragments to be augmented into the trained recommendation model to obtain several augmented knowledge fragments and their sequencing; and
a question-answering module, configured to splice the augmented knowledge fragments according to their sequencing, embedding them in the prompt template, and then inputting it into a large language model to obtain a user's preferred answer to the question.

The present disclosure has the following beneficial effects:

The retrieval-augmented generation method, system, device, and medium and the question-answering method and system described in the present disclosure optimize the retrieval process of RAG based on a trained embedding model during specific operation to make its information more accurate. Then, by means of the trained recommendation model, the retrieved results are further screened and sequenced, so that the results of RAG can gradually meet user preferences and usage habits during use, thereby realizing large-scale customized deployment.

### BRIEF DESCRIPTION OF DRAWINGS

The drawings of the specification forming a part of the present disclosure are used to provide a further understanding of the present disclosure. The exemplary embodiments of the present disclosure and their descriptions are only for explaining the present disclosure and do not unduly limit the present disclosure. Reference numerals:

FIG. 1 is a flow chart of a retrieval-augmented generation method according to the present disclosure.

FIG. 2 is a training flow chart of a recommendation model according to the present disclosure.

FIG. 3 is a flow chart of a question-answering method according to the present disclosure.

FIG. 4 is a structural diagram of a retrieval-augmented generation system according to the present disclosure.

FIG. 5 is a structural diagram of a question-answering system according to the present disclosure.

FIG. 6 is a structural diagram of a first conversion module according to the present disclosure.

FIG. 7 is a structural diagram of a first building module according to the present disclosure.

### DETAILED DESCRIPTION OF THE EMBODIMENTS

In order to enable personnel in this technical field to better understand solutions of the present disclosure, the following will combine the accompanying drawings in the embodiments of the present disclosure to clearly and completely describe the technical solutions in the embodiments of the present disclosure. Obviously, the described embodiments are only part of the embodiments of the present disclosure, not all of them, and are not intended to limit the scope of the disclosure of the present application. In addition, well-known structures and techniques are omitted in the following description to avoid unnecessarily obscuring the concepts of the present disclosure. Based on the embodiments described herein, all other embodiments obtained by those of ordinary skill in the art without creative work are within the scope of protection of the present disclosure.

Schematic diagrams of the structure according to embodiments in the present disclosure are shown in the accompanying drawings. These figures are not drawn to scale, where some details have been exaggerated and may be omitted for the purpose of clarity. The shapes of the various regions and layers shown in the figures and their relative sizes and positional relationships are only exemplary. In practice, there may be deviations due to manufacturing tolerances or technical limitations. Those skilled in the art can design additional regions/layers with different shapes, sizes, and relative positions according to actual needs.

The present disclosure is oriented to the retrieval-augmented generation (RAG) scenario, and proposes a method for continuous learning based on the preferences shown in the user interaction process. Preference learning is performed in two aspects during the embedding process and the recommendation sequencing process of the initial search results, so that the RAG algorithm is more in line with usage habits during use and large-scale customized deployment can be achieved.

### Embodiment 1

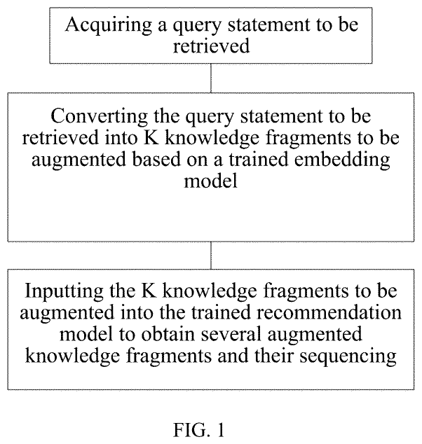

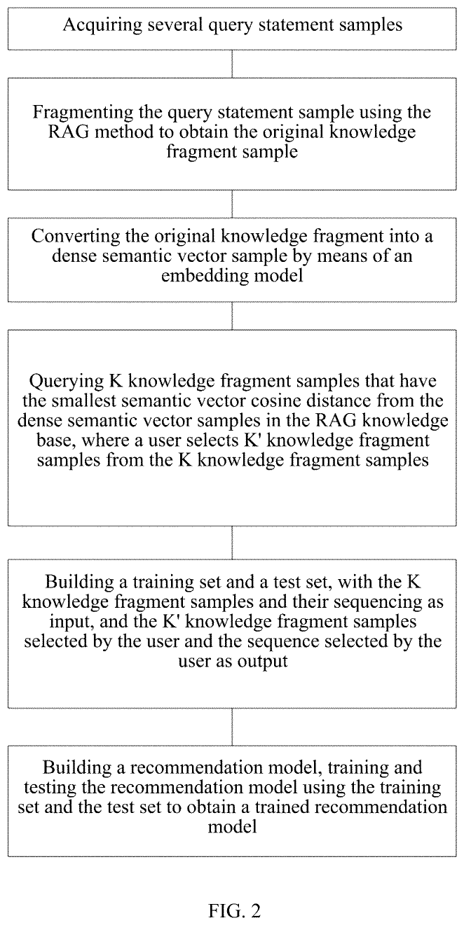

Referring to FIG. 1, the retrieval-augmented generation method of the present disclosure includes the following steps:
11) acquiring a query statement to be retrieved;
12) converting the query statement to be retrieved into K knowledge fragments to be augmented based on a trained embedding model M; and
referring to FIG. 2, the process of step 12) is as follows:
121) RAG knowledge base;
the process of step 121) is as follows:
processing the input data using the RAG method to obtain a knowledge fragment p, inputting the knowledge fragment p into the trained embedding model to convert the knowledge fragment p into a dense semantic vector [symbol] ^{N*×1024}, and building a RAG knowledge base based on the knowledge fragment p and its corresponding dense semantic vector [symbol] ^{N*×1024}.

As an embodiment of the present disclosure, the process of processing the input data using the RAG method to obtain a knowledge fragment p is as follows:
fragmenting the input data into segments of a fixed length (500-700 characters) with a cross-segment overlap of 50-100 characters, resulting in a set of knowledge fragments p.

As an embodiment of the present disclosure, the embedding model M includes but is not limited to BERT and its variant embedding models, Sentence-Transformer, and BAAI-BGE.

As an embodiment of the present disclosure, the knowledge fragments p in the RAG knowledge base correspond to dense semantic vectors [symbol] ^{N*×1024} one by one.

As an example, in an intelligent Q&A application, inputting the query statement to be retrieved will return multiple knowledge fragments, such as “Default Directory”, “Information on Enterprises to Be Settled in a Certain Place”, “Basic Information of Applicants” and “Applicant Profile”, which can present specific content corresponding to the knowledge fragments. Each knowledge fragment represents the path from the document to a specific chapter in the document.

It should be noted that the knowledge fragments in the knowledge base actually split a document according to the title hierarchy, and the underlying nodes are used as fragments. In actual applications, the fragments can also be previewed and automatically labeled. Each knowledge fragment can contain text, images, tables, etc.

As an embodiment of the present disclosure, this embodiment further includes: online training of the embedding model.

In the process of online training of the embedding model, an embedding model training trigger threshold Tis set. As the number of interactions between the user and the system increases, the data available for model training will also increase. When the amount of trainable data exceeds T, the training of the embedding model will be triggered. The present disclosure performs full-parameter fine-tuning training of the embedding model by default. However, when a user uses a model with a Transformer architecture, the user is allowed to specify the frozen attention mechanism layer. The parameters of the frozen model layer will not participate in the training process, which can reduce the load of embedding model training. The fine-tuning training of the embedding model will affect its embedding of all knowledge fragments in the knowledge base and a user's query questions, so it is a global optimization of the entire RAG process. In practical applications, the embedding model training trigger threshold Tis an important hyperparameter for fine-tuning the model and cannot be modified by the user. A parameter configuration file will be set locally to modify and adjust the embedding model training trigger threshold T.
122) Converting the query statement input by a user into a query vector l using the trained embedding model, querying the K knowledge fragments that have the shortest distance from the query vector l in the RAG knowledge base based on the semantic cosine distance, and using the K knowledge fragments as the K knowledge fragments to be augmented.

After conversion to a query vector, the specific statement is converted into a semantic vector form for subsequent processing. The K knowledge fragments screened out are actually a result of query statements and all the fragments in the knowledge base for similarity calculation, sequenced from high to low, and returned the highest K.
13) Obtaining the trained recommendation model, and inputting the K knowledge fragments to be augmented into the trained recommendation model to obtain several augmented knowledge fragments and their sequencing.

The process of step 13) is as follows:
131) building a training set and a test set;
132) acquiring several query statement samples;
133) converting the query statement sample into a dense semantic vector sample by means of the embedding model;
134) querying K knowledge fragment samples that have the smallest semantic vector cosine distance from the dense semantic vector samples in the RAG knowledge base, where during the interaction process, a user selects K′ knowledge fragment samples from the K knowledge fragment samples;
135) building a training set and a test set, with the K knowledge fragment samples and their sequencing as input, and the K′ knowledge fragment samples selected by the user and the sequence selected by the user as output;
136) building a recommendation model based on Bi-LSTM network (based on bidirectional long short-term memory deep learning network); and
137) training and testing the recommendation model using the training set and the test set to obtain a trained recommendation model.

It should be noted that the system address and content of the knowledge fragment selected by the user are recorded, and each knowledge fragment is sequenced in the order in which the user selects the knowledge fragment, in which the system address represents an absolute path of the knowledge fragment in the local computer file system, and the content is the actual content of the knowledge fragment. In addition, K′ knowledge fragments selected by the user are used as positive samples, and K-K′ knowledge fragments not selected by the user are used as negative samples.

In addition, it should be noted that the present disclosure trains a recommendation model based on the knowledge fragment samples selected by the user and their selection order, that is, the knowledge fragment samples preferred by the user, which can enable the recommendation model to meet the user's preferences and data interaction habits. Moreover, the present disclosure optimizes the retrieval process of RAG based on fine-tuning the training vector embedding model to make its information more accurate. Then, by training the recommendation model, the retrieved results are further screened and sequenced, so that the RAG results can gradually meet user preferences and usage habits during use, realizing large-scale customized deployment.

### Embodiment 2

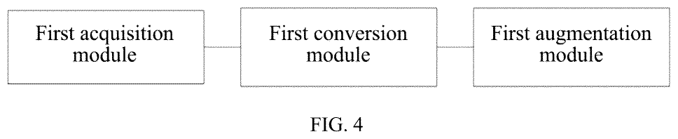

Accordingly, referring to FIG. 4, the retrieval-augmented generation system of the present disclosure includes:
a first acquisition module, configured to obtain the query statement to be retrieved;
a first conversion module, configured to convert the query statement to be retrieved into K knowledge fragments to be augmented based on a trained embedding model; and
a first augmentation module, configured to input the K knowledge fragments to be augmented into the trained recommendation model to obtain several augmented knowledge fragments and their sequencing.

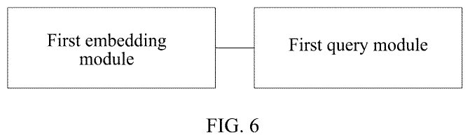

As an embodiment of the present disclosure, referring to FIG. 6, the first conversion module includes:
a first embedding module, configured to convert a query statement to be retrieved into a dense semantic vector by means of a trained embedding model; and
a first query module, configured to query K knowledge fragments that have the smallest semantic vector cosine distance from the dense semantic vector in the RAG knowledge base, and use the queried K knowledge fragments as the K knowledge fragments to be augmented.

As an embodiment of the present disclosure, this embodiment further includes:
a first building module, configured to build a training set and a test set;
a second building module, configured to build a recommendation model;
a training module, configured to train and test the recommendation model using the training set and the test set to obtain a trained recommendation model.

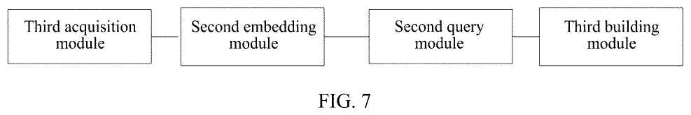

As an embodiment of the present disclosure, referring to FIG. 7, the first building module includes:
a third acquisition module, configured to acquire several query statement samples;
a second embedding module, configured to convert the query statement sample into a dense semantic vector sample by means of the embedding model;
a second query module, configured to query K knowledge fragment samples that have the smallest semantic vector cosine distance from the dense semantic vector samples in the RAG knowledge base, where a user selects K′ knowledge fragment samples from the K knowledge fragment samples; and
a third building module, configured to build a training set and a test set, with the K knowledge fragment samples and their sequencing as input, and the K′ knowledge fragment samples selected by the user and the sequence selected by the user as output.

As an embodiment of the present disclosure, the process of building a recommendation model is as follows:
building a recommendation model based on the Bi-LSTM network.

The division of modules in the embodiments of the present disclosure is schematic and is only a logical function division. There may be other division methods in actual implementation. In addition, each functional module in each embodiment of the present disclosure can be integrated into one processor, or it can exist physically separately, or two or more modules can be integrated into one module. The above-mentioned integrated module can be implemented in the form of hardware or as software functional module.

### Embodiment 3

A computer device includes a storage, a processor, and a computer program stored in the storage and executable on the processor. When the processor performs the computer program, it implements the steps of the retrieval-augmented generation method, for example, including: acquiring a query statement to be retrieved; converting the query statement to be retrieved into K knowledge fragments to be augmented based on a trained embedding model; and inputting the K knowledge fragments to be augmented into the trained recommendation model to obtain several augmented knowledge fragments and their sequencing. Among them, the storage may include a memory, such as a high-speed random access memory, and may also include a non-volatile memory, such as at least one magnetic disk memory, etc.; the processor, network interface, and storage are interconnected through an internal bus, which can be an industrial standard architecture bus, a peripheral component interconnection standard bus, an extended industrial standard structure bus, etc. The bus can be an address bus, a data bus, a control bus, etc. The storage is configured to store programs, specifically, the program may include program code, and the program code includes computer operation instructions. The storage may include a memory and a non-volatile memory, and provide instructions and data to the processor.

### Embodiment 4

A computer-readable storage medium, where the computer-readable storage medium stores a computer program, in which the steps of implementing the retrieval-augmented generation method when the computer program is performed by a processor include, for example: acquiring a query statement to be retrieved; converting the query statement to be retrieved into K knowledge fragments to be augmented based on a trained embedding model; and inputting the K knowledge fragments to be augmented into the trained recommendation model to obtain several augmented knowledge fragments and their sequencing. Specifically, the computer-readable storage medium includes but is not limited to, for example, volatile memory and/or non-volatile memory. The volatile memory may include random access memory (RAM) and/or cache, etc. The non-volatile memory may include read-only memory (ROM), hard disk, flash memory, optical disk, magnetic disk, etc.

### Embodiment 5

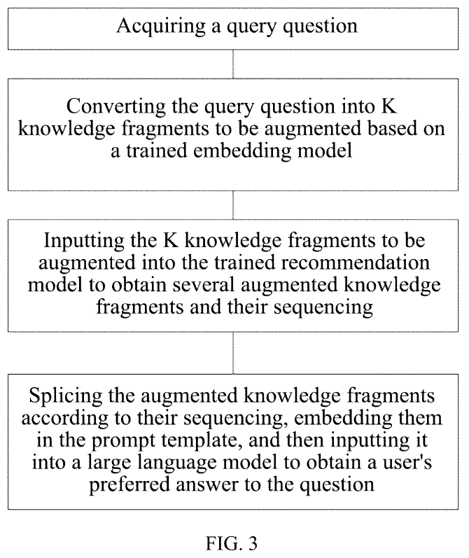

Referring to FIG. 3, the question-answering method according to the present disclosure includes:
21) acquiring a query question;
22) converting the query question into K knowledge fragments to be augmented based on a trained embedding model; and
the process of step 22) is as follows:
inputting a query question into the embedding model, converting the query question into a vector, querying the K knowledge fragments that have the shortest distance from the vector in the RAG knowledge base based on the semantic cosine distance, and using the K knowledge fragments as the K knowledge fragments to be augmented.
23) Inputting the K knowledge fragments to be augmented into the trained recommendation model to obtain several augmented knowledge fragments and their sequencing;
where in step 23), the training process of the recommendation model is shown in steps 131) to 137) in Embodiment 1.
24) Splicing the augmented knowledge fragments according to their sequencing, embedding them in the prompt template, and then inputting it into a large language model to obtain a user's preferred answer to the question.

As an embodiment of the present disclosure, the large language model includes but is not limited to closed-source large models such as Tongyi Qianwen, Wenxin Yiyan, Baichuan, Zidong Taichu, and open-source large models such as Llama.

### Embodiment 6

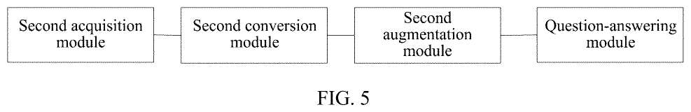

Referring to FIG. 5, the question-answering system of the present disclosure includes:
a second acquisition module, configured to acquire a query question;
a second conversion module, configured to convert the query question into K knowledge fragments to be augmented based on a trained embedding model; and
a second augmentation module, configured to input the K knowledge fragments to be augmented into the trained recommendation model to obtain several augmented knowledge fragments and their sequencing; and
a question-answering module, configured to splice the augmented knowledge fragments according to their sequencing, embedding them in the prompt template, and then inputting it into a large language model to obtain a user's preferred answer to the question.

As an embodiment of the present disclosure, input a query question into a trained embedding model, convert the query question into a vector, query the K knowledge fragments that have the shortest distance from the vector in the RAG knowledge base based on the semantic cosine distance, and use the K knowledge fragments as the K knowledge fragments to be augmented.

As an embodiment of the present disclosure, the training process of the recommendation model is shown in steps 131) to 137) in Embodiment 1.

As an embodiment of the present disclosure, the large language model includes but is not limited to closed-source large models such as Tongyi Qianwen, Wenxin Yiyan, Baichuan, Zidong Taichu, and open-source large models such as Llama.

The division of modules in this embodiment is schematic and is only a logical function division. There may be other division methods in actual implementation. In addition, each functional module in each embodiment of the present disclosure can be integrated into one processor, or it can exist physically separately, or two or more modules can be integrated into one module. The above-mentioned integrated module can be implemented in the form of hardware or as software functional module.

### Embodiment 7

A computer device includes a storage, a processor, and a computer program stored in the storage and executable on the processor. When the processor performs the computer program, it implements the steps of the question-answering method, for example, including: acquiring a query question; converting the query question into K knowledge fragments to be augmented based on a trained embedding model; inputting the K knowledge fragments to be augmented into the trained recommendation model to obtain several augmented knowledge fragments and their sequencing; and splicing the augmented knowledge fragments according to their sequencing, embedding them in the prompt template, and then inputting it into a large language model to obtain a user's preferred answer to the question. Among them, the storage may include a memory, such as a high-speed random access memory, and may also include a non-volatile memory, such as at least one magnetic disk memory, etc.; the processor, network interface, and storage are interconnected through an internal bus, which can be an industrial standard architecture bus, a peripheral component interconnection standard bus, an extended industrial standard structure bus, etc. The bus can be an address bus, a data bus, a control bus, etc. The storage is configured to store programs, specifically, the program may include program code, and the program code includes computer operation instructions. The storage may include a memory and a non-volatile memory, and provide instructions and data to the processor.

### Embodiment 8

A computer-readable storage medium, where the computer-readable storage medium stores a computer program, in which the steps of implementing the question-answering method when the computer program is performed by a processor include, for example: acquiring a query question; converting the query question into K knowledge fragments to be augmented based on a trained embedding model; inputting the K knowledge fragments to be augmented into the trained recommendation model to obtain several augmented knowledge fragments and their sequencing; and splicing the augmented knowledge fragments according to their sequencing, embedding them in the prompt template, and then inputting it into a large language model to obtain a user's preferred answer to the question. Specifically, the computer-readable storage medium includes but is not limited to, for example, volatile memory and/or non-volatile memory. The volatile memory may include random access memory (RAM) and/or cache, etc. The non-volatile memory may include read-only memory (ROM), hard disk, flash memory, optical disk, magnetic disk, etc.

Those skilled in the art will appreciate that embodiments of the present disclosure may be provided as methods, systems, or computer program products. Therefore, the present disclosure can take the form of a complete hardware embodiment, a complete software embodiment, or an embodiment combining software and hardware aspects. Moreover, the present disclosure can take the form of a computer program product implemented on one or more computer-usable storage media (including but not limited to magnetic disk memory, CD-ROM, optical memory, etc.) containing computer-usable program codes.

The present disclosure is described with reference to flowcharts and/or block diagrams of methods, devices (systems), and computer program products according to embodiments of the present disclosure. It should be understood that each process and/or box in the flowchart and/or block diagram, as well as a combination of processes and/or boxes in the flowchart and/or block diagram, can be implemented by computer program instructions. These computer program instructions can be provided to a processor of a general-purpose computer, a special-purpose computer, an embedded processor or other programmable data processing device to generate a machine, so that the instructions performed by the processor of the computer or other programmable data processing device generate a device for realizing the functions specified in one process or multiple processes of the flowchart and/or one box or multiple boxes of the block diagram.

These computer program instructions may also be stored in a computer-readable memory capable of directing a computer or other programmable data processing device to operate in a specific manner, so that the instructions stored in the computer-readable memory produce an article of manufacture including instruction means, which implements the functions specified in one process or multiple processes of the flowchart and/or one box or multiple boxes of the block diagram.

These computer program instructions may also be loaded onto a computer or other programmable data processing device, so that a series of operation steps are performed on the computer or other programmable device to produce a computer-implemented process, whereby the instructions executed on the computer or other programmable device provide steps for implementing the functions specified in one or more processes of a flowchart and/or one or more boxes of a block diagram.

Finally, it should be noted that: The above embodiments are only used to illustrate the technical solutions of the present disclosure and not to limit them. Although the present disclosure is described in detail with reference to the above embodiments, ordinary technicians in the field should understand that: The specific embodiments of the present disclosure can still be modified or replaced by equivalents, and any modification or equivalent replacement that does not deviate from the spirit and scope of the present disclosure should be covered within the scope of protection of the claims of the present disclosure.

What is claimed is:

1. A retrieval-augmented generation method, comprising:
acquiring a query statement to be retrieved;
converting the query statement to be retrieved into K knowledge fragments to be augmented based on a trained embedding model; and
inputting the K knowledge fragments to be augmented into the trained recommendation model to obtain several augmented knowledge fragments and their sequencing.

2. The retrieval-augmented generation method according to claim 1, wherein the process of converting the query statement to be retrieved into K knowledge fragments to be augmented based on a trained embedding model is as follows:
converting the query statement to be retrieved into a dense semantic vector by means of a trained embedding model; and
querying K knowledge fragments that have the smallest semantic vector cosine distance from the dense semantic vector in the RAG knowledge base, and using the queried K knowledge fragments as the K knowledge fragments to be augmented.

3. The retrieval-augmented generation method according to claim 1, wherein before inputting the K knowledge fragments to be augmented into the trained recommendation model, the method further comprises:
building a training set and a test set;
building a recommendation model; and
training and testing the recommendation model using the training set and the test set to obtain a trained recommendation model.

4. The retrieval-augmented generation method according to claim 3, wherein the process of building a training set and a test set is as follows:
acquiring several query statement samples;
converting the query statement sample into a dense semantic vector sample by means of the embedding model;
querying K knowledge fragment samples that have the smallest semantic vector cosine distance from the dense semantic vector samples in the RAG knowledge base, where a user selects K′ knowledge fragment samples from the K knowledge fragment samples; and
building a training set and a test set, with the K knowledge fragment samples and their sequencing as input, and the K′ knowledge fragment samples selected by the user and the sequence selected by the user as output.

5. The retrieval-augmented generation method according to claim 3, wherein the process of building a recommendation model is as follows:
building a recommendation model based on the Bi-LSTM network.

6. A retrieval-augmented generation system, comprising:
a first acquisition module, configured to obtain the query statement to be retrieved;
a first conversion module, configured to convert the query statement to be retrieved into K knowledge fragments to be augmented based on a trained embedding model; and
a first augmentation module, configured to input the K knowledge fragments to be augmented into the trained recommendation model to obtain several augmented knowledge fragments and their sequencing.

7. A computer device, comprising a storage, a processor, and a computer program stored in the storage and executable on the processor, wherein when the processor performs the computer program, it implements the steps of the retrieval-augmented generation method according to claim 1.

8. A computer-readable storage medium, the computer-readable storage medium storing a computer program, wherein the computer program implements the steps of the retrieval-augmented generation method according to claim 1 when performed by a processor.

9. A question-answering method, comprising:
acquiring a query question;
converting the query question into K knowledge fragments to be augmented based on a trained embedding model;
inputting the K knowledge fragments to be augmented into the trained recommendation model to obtain several augmented knowledge fragments and their sequencing; and
splicing the augmented knowledge fragments according to their sequencing, embedding them in the prompt template, and then inputting it into a large language model to obtain a user's preferred answer to the question.
